(19) United States
(12) Patent Application Publication
(10) Pub. No.: US 2026/0304127 A1
(43) Pub. Date: Oct. 1, 2026

(54) AI-ASSISTED THREAT DETECTION AND MITIGATION

(71) Applicant: InterDigital Patent Holdings, Inc., Wilmington, DE (US)

(72) Inventors: Zhibi Wang, Woodridge, IL (US); Samir Ferdi, Kirkland (CA); Alec Brusilovsky, Downingtown, PA (US); Chonggang Wang, Princeton, NJ (US); Yi Zhang, San Jose, CA (US)

(73) Assignee: InterDigital Patent Holdings, Inc., Wilmington, DE (US)

(21) Appl. No.: 19/092,826

(22) Filed: Mar. 27, 2025

(51) Int. Cl. H04W 12/122

(52) U.S. Cl. CPC H04W 12/122

(57) ABSTRACT

Methods, apparatuses, and systems are disclosed. In one example, a method performed by a network device in a cellular network includes receiving a notification, the notification comprising an indication that a security incident associated with the cellular network has been detected, an indication of a type of the security incident, and an indication of a first network entity associated with the security incident; determining, via an artificial intelligence (AI) model based on the notification, at least one action to be performed by a second network entity in response to the security incident; and sending an indication of the at least one action to the second network entity to instruct the second network entity to perform the at least one action.

### BACKGROUND

In the 5G system, there is limited support for Artificial Intelligence and/or Machine Learning (AIML). However, next generation systems (e.g., 6G) may provide more support for AIML functionality to enhance cellular network performance as measured by various metrics.

### SUMMARY

Methods and apparatuses for operation by a network device in a network are provided.

In one example, a method performed by a network device in a cellular network may include receiving a notification, the notification comprising an indication that a security incident associated with the cellular network has been detected, an indication of a type of the security incident, and an indication of a first network entity associated with the security incident; determining, via an artificial intelligence (AI) model based on the notification, at least one action to be performed by a second network entity in response to the security incident; and sending an indication of the at least one action to the second network entity to instruct the second network entity to perform the at least one action.

The at least one action may comprise a configuration update for the cellular network.

The first network entity associated with the security incident may be a wireless transmit/receive unit (WTRU), and the at least one action may comprise reducing an aggregate maximum bit rate for the WTRU.

The type of the security incident may be a signaling storm. The at least one action may comprise a signaling message processing capability adaptation, load balancing, an interface bandwidth change, or throttling a signaling load.

The first network entity associated with the security incident may be an application function (AF). The type of the security incident may be a malformed service-based interface (SBI) request or a large volume of SBI application programming interface (API) invocations between the AF and a network exposure function (NEF) with an unusual information element (IE) in an SBI header.

The second network entity may comprise a network repository function (NRF). The first network entity associated with the security incident may comprise a network function (NF).

The at least one action may comprise the NRF removing a stored profile for the NF.

The second network entity may comprise a service communication proxy (SCP). The first network entity associated with the security incident may comprise a network function (NF).

The at least one action may comprise the SCP refraining from providing an authorization token for communication with the NF.

The second network entity may comprise a session management function (SMF). The at least one action may comprise the SMF releasing a protocol data unit (PDU) session.

The method may further include, prior to receiving the notification, sending a request to subscribe to AI security analytics derived by a second AI model.

The method may further comprise sending an acknowledgment in response to receiving the notification.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates a simplified version of the 5G system architecture.

FIG. 3 illustrates a control plane stack between a WTRU and an AMF.

FIG. 4 illustrates an example architecture (e.g., Next Gen Network Architecture) with AI-assisted security.

FIG. 5 shows a table that illustrates some types of data that may be collected and used by an AI security controller.

FIG. 6 illustrates an example call flow diagram for AI-based threat detection and/or response.

### DETAILED DESCRIPTION

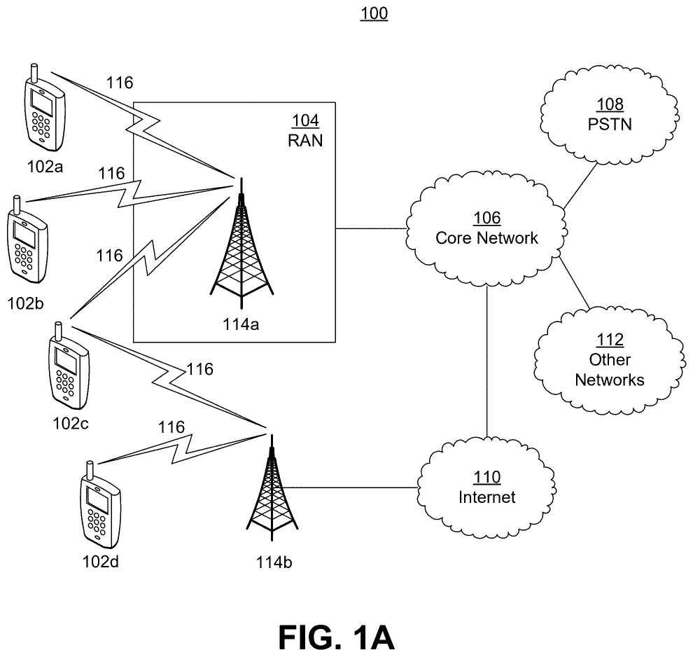

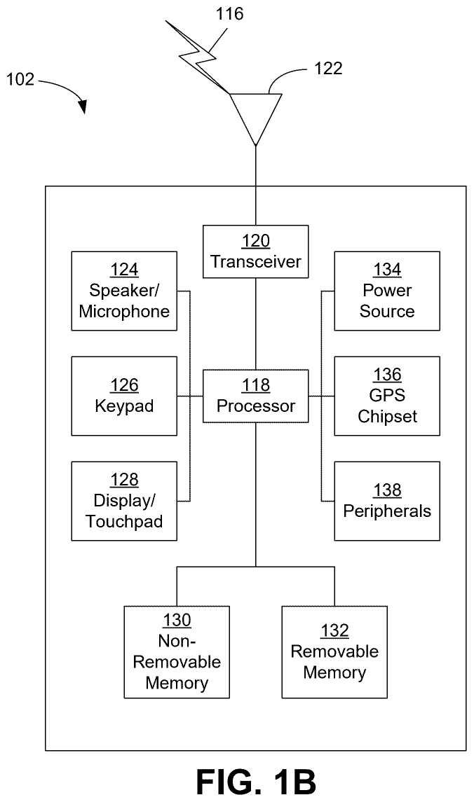

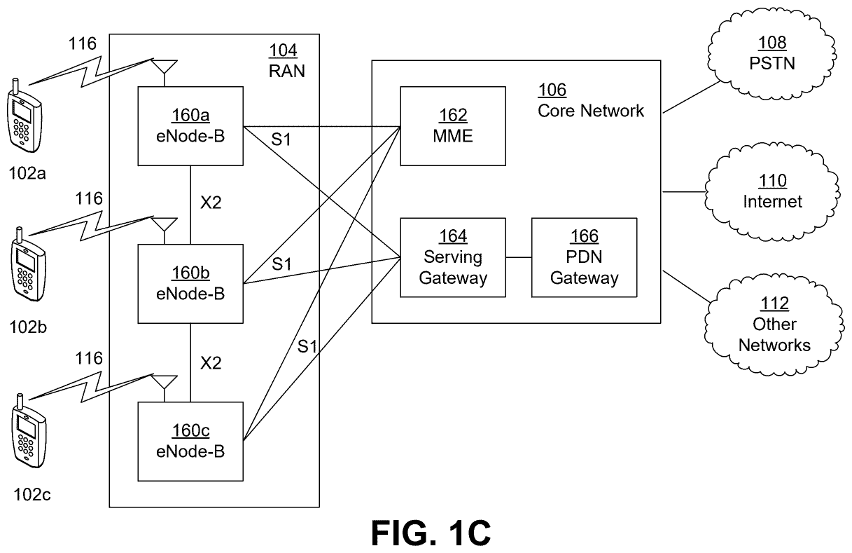

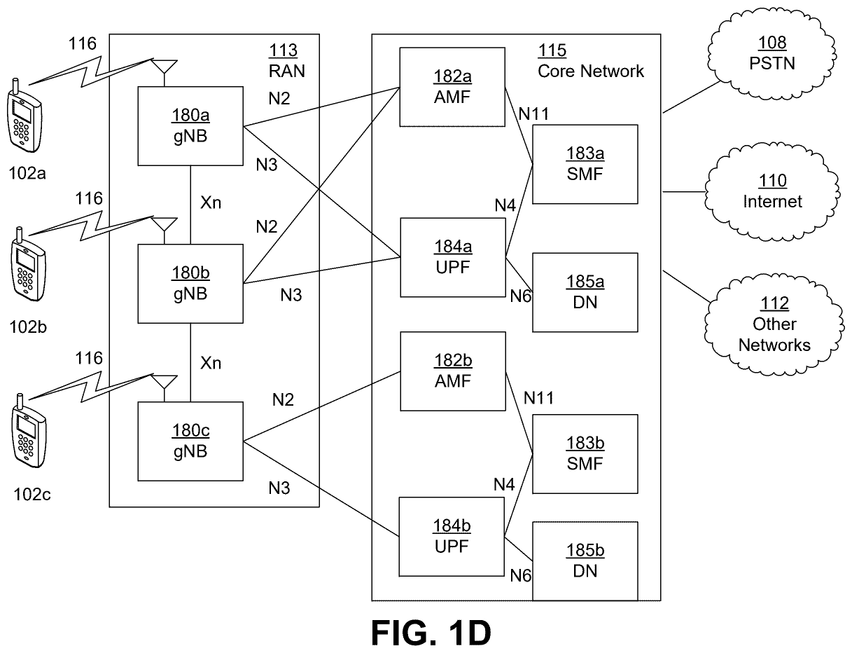

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration.

In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods disclosed herein pertain to security in 6G networks. For instance, technologies for AI Assisted Security for 6G, a Data Collecting Framework, an AI Security Architecture for 6G, and AI-Assisted Incidence Response are described herein.

Systems and methods for AI-Assisted security in 6G may autonomously collect network data, detect threats, formulate AI-assisted responses to security incidents by isolating entities involved in those security incidents, and perform AI-assisted recovery from failures and/or attacks. The data may be continuously collected from network NFs and WTRUs. The system and methods for AI-Assisted security in 6G may continuously update and re-train the AI models used to perform these tasks.

The data collecting frameworks described herein may be designed to detect and respond to the 6G network security events (e.g., advance persistent threats (APTs), distributed denial of service (DDoS) attacks, malicious insider attacks, man-in-the-middle (MiTM) attacks, information disclosure, signaling storm attacks, etc.) in an AI-assisted, dynamically adapting networking environment and/or configuration via dynamic and/or flexible networking (e.g., software-defined security). The AI-assisted responses may comprise, for example isolation, throttling, updating security policies, capability adaptation (e.g., adding and/or changing of capabilities), load balancing, interface bandwidth changing, and/or changing a topology and/or configuration.

In one example, AI-assisted detection and/or response to a signaling storm (e.g., a DDoS attack) may be performed using AI-assisted network reconfiguration and/or NF capability updates. The AI model used to implement the AI-assisted detection and/or response may be adapted and/or re-trained with an updated network configuration and/or interfaces. In another example, AI-assisted incident detection and/or response is performed when a compromised device accesses an unauthorized resource. The AI-assisted incident detection and/or response may include AI-assisted dynamical restriction of permissions (such as by a security access policy update) and/or isolation of the compromised device.

6G networks have the potential to be highly dynamic, intelligent, and self-sustaining, leveraging AI-driven anomaly detection and self-healing mechanisms to identify proactively and mitigate cyber threats, operational failures, and/or performance degradation.

AI-assisted anomaly detection in 6G networks has the potential to rely on AI agents continuously monitoring network behavior to identify irregular patterns that indicate cyberattacks, hardware malfunctions, or service disruptions. There are many types of anomalies that may be detected in different sources within a network and may evince cyber threats, operational failures, and/or performance degradation.

For example, within a RAN, rogue base stations and/or signal interference may evince jamming attacks and/or unauthorized spectrum usage. Within a WRTU, unauthorized access and/or compromising of the WTRU may evince that the WTRU is being controlled by a botnet and/or that identity spoofing is occurring. Within a CN, traffic anomalies and/or data exfiltration may evince DDoS attacks and/or insider threats. With applications and/or API logs, API misuse and/or privilege escalation may evince unauthorized API calls and/or session hijacking. Within network slices, service degradation and/or misconfigurations may evince slicing misallocation and/or inter-slice attacks.

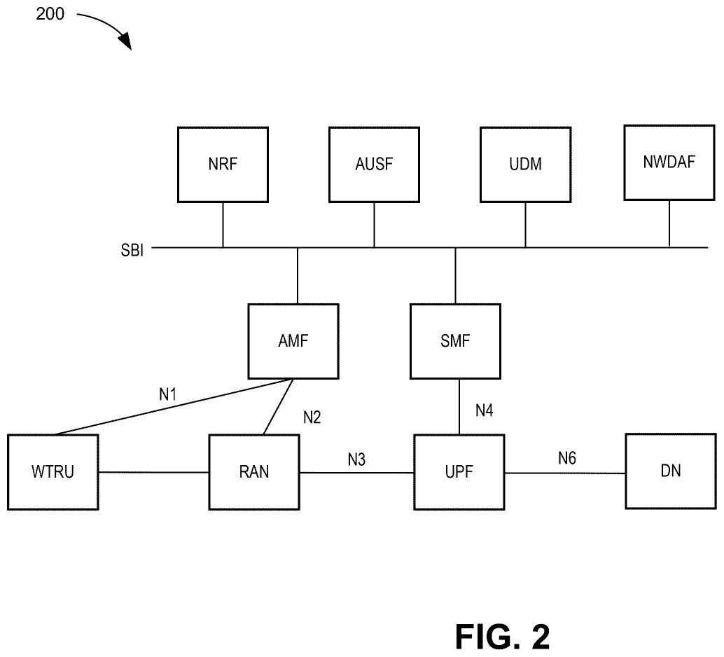

FIG. 2 illustrates a simplified version of the 5G System Architecture 200 (e.g., as defined in the Third Generation Partnership Project (3GPP) Technical Specification (TS) 23.501 v18.5.0), where a subset of the Network Functions (NFs) in the 5G Core are represented (e.g., some NFs in the 5G core are not shown).

The NFs, such as the AMF, the SMF, and the Unified Data Management (UDM) communicate with each other using the Service Based Interface (SBI) (e.g., using protocols like Hypertext Transfer Protocol (HTTP)). One goal of the Service Base Architecture (SBA) is to enable NFs to expose services (e.g., using Representational State Transfer (REST)-ful Application Programming Interfaces (APIs)) to other NFs for the system to provide desired functionality.

The other interfaces (e.g., N1, N2, N5, N4, N6) shown in FIG. 2 and described below are different from the SBI.

The WTRU may communicate with the AMF over N1 using a Non-access Stratum (NAS) protocol. Control plane messaging between the WTRU and other NFs (e.g., the SMF) may be done using an NAS transport encapsulation mechanism provided by the AMF for the NFs.

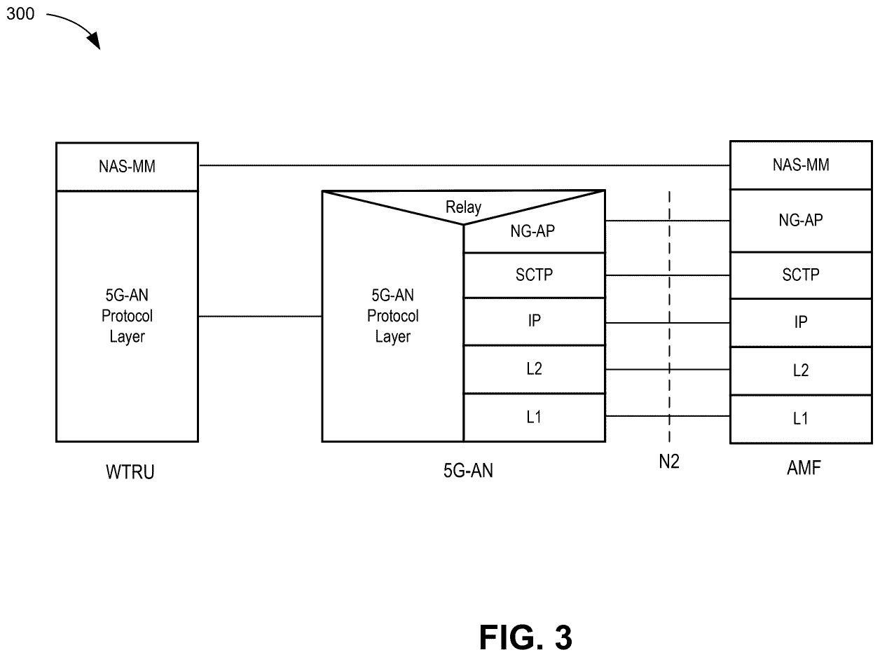

FIG. 3 illustrates a control plane stack 300 between a WTRU and an AMF. As illustrated in FIG. 3, the RAN communicates with the AMF over N2 using a Next Generation Application Protocol (NGAP). Control plane messaging between the WTRU and the RAN (Access Stratum (AS)) may be done using Radio Resource Control (RRC) (top of the 5G Access Network (AN) Protocol layers) which is used to transport NAS messages received or sent by the RAN over N2.

In the 5G system, there is limited support for Artificial Intelligence and/or Machine Learning (AIML) such as federated learning, AIML-based Learning Classifier Systems (LCSs), etc., and basic functionality to support AIML. The Next Generation Network architecture may continue to push further the shift started in 5G to embrace a native Artificial Intelligence (AI) implementation in the Core Network-especially with regard to AI-assisted security in the 6G Architecture. Some examples of AI-assisted security are described in the examples below.

In AI-assisted security systems within the 6G architecture, multilayered intrusion detection and prevention may utilize deep reinforcement learning and Deep Neural Networks (DNN) in Software-Defined Networking (SDN) and Network Functions Virtualization (NFV) environments to defend effectively against Internet Protocol (IP) spoofing, flow table overloading, Distributed Denial-of-Service (DDoS) attacks, control plane saturation, and host location hijacking.

In AI-assisted security systems within the 6G architecture, Machine Learning (ML) approaches (e.g., Decision Trees and/or Random Forests) may be used for detecting DDoS attacks due to their short processing time and accuracy against dynamic attacks on SDN/NFV, adapting to the evolving threat landscape.

In AI-assisted security systems within the 6G architecture, anomaly-based intrusion detection in the Industrial IoT (IloT) may detect malicious packets based on behavior and may be suitable for identifying zero-day attacks using communication-link attributes and user behaviors for authentication and/or authorization, conserving resources on constrained devices.

In AI-assisted security systems within the 6G architecture, learning-based security in sub-Networks may involve using ML models deployed at the perimeter to capture behavior of other sub-networks, detecting malicious traffic to enhance communication efficiency by sharing learned security intelligence between sub-networks and/or reducing unnecessary data transfer.

The Next Generation Network architecture may continue to push further the shift started in 5G to embrace a native AI implementation in the Core Network, especially AI assisted security in 6G Architecture.

Nevertheless, there may be data collection challenges in the next generation network. Some examples of these challenges are listed below.

One challenge is data quality. Poor data quality may result from data entry errors, incomplete data sets, and outdated information and may lead to incorrect insights and wasted resources.

Data Security is another challenge. Protecting sensitive data throughout its lifecycle—from collection to storage to disposal—is a challenge to address to prevent unauthorized access that leads to data breaches and loss of trust.

Data Privacy is another challenge. Ensuring that collected data is used responsibly and complies with privacy regulations is a challenge to address to prevent data privacy breaches and misuse.

Data Integration—e.g., combining data from multiple sources to create a unified view to aggregate data from fragmented sources—is another challenge.

Contextual Understanding is yet another challenge. A lack of understanding of the context in which data is collected can lead to misinterpretation of data and can lead to incorrect conclusions.

Given the challenges listed above and other challenges, a problem to be addressed for AI to secure a next generation wireless network is how to integrate the AI functionality into the 6G network architecture seamlessly for increased network resilience and security. For example, how will the data used in conjunction with AI functionality be collected and processed efficiently to detect any security incidents? How can network AI capabilities be leveraged to assist in detecting and responding to security incidents (e.g., signaling storm, DDoS attack, misbehaving WTRUs and/or network devices, etc.) appropriately?

The present disclosure describes technological solutions for addressing the challenges and/or problems described above.

To address these challenges and/or problems, one or more actions (e.g., steps) may be performed (e.g., as described in the examples below).

In an example, an AI Security Analytic may receive a subscription from an AI Security Controller for the AI analytics derived by an AI Model for an anomaly detected by the AI model.

An AI Security Analytic (AISA) (e.g., it may collocated with Network Data Analytic Function (NWDAF)) may subscribe with WTRUs, NFs, and/or a Service Communication Proxy (SCP) and a Network Repository Function (NRF) to the network information that is described in further detail below, such as signaling data and signaling traffic load-related information via an AI data collector that may be integrated in an entity (e.g., a network entity) where monitoring data (e.g., the network information) is collected. The AI analytic function (e.g., NWDAF) may receive data notification when the data (e.g., monitoring data) are available. Note that a subscribe acknowledgment may be omitted in this example call-flow.

The AI analytic function may validate, clean, and process the collected data to predict and/or detect a network anomaly such as a signaling storm, a DDoS attack, and/or a compromised device that tries to access an unauthorized resource. The AI analytic may identify the NFs and interfaces impacted by the security incident (e.g., signaling storm, etc.) and identify the root course and NFs along with the interfaces involved. The AI analytic may send the incident notification to authorized subscribers, such as the AI Security Controller (AISC) mentioned above.

The AI security analytic (e.g., NWDAF) may notify the AI security controller and communicate the anomaly, the associated root course, the entity ID involved, etc.

If there is a reason to update the AI model due to the actions taken in response to the security incident (e.g., network anomaly) mentioned above, the existing AI Model and an associated network configuration may be saved for future reference. The AI model may be updated and/or re-trained for a new network configuration.

In another example, the AISC may subscribe to the AI analytics derived by an AI Model that may be collocated with an NWDAF. The AISC may be collocated with a security policy repository and/or configured with the security policy repository address.

The AISC may receive a notification from the AI Security Analytic/NWDAF that communicates the anomaly, the associated root course, the entity ID involved, etc.

The AISC may decide the actions on the received incident (e.g., security incident) mentioned above based on a security policy. The actions may include a network configuration update, a processing capability adaptation, NF isolation, load balancing, interface Bandwidth (BW) changes, load, throttling, disabling one or more services, an NF restart, a firewall policy update, software/firmware updates, etc. For example, if a signaling storm is identified, the network configuration (e.g., signaling message processing capability adaptation, load balancing, interface BW changes, etc.) may be updated.

Sthe AISC may send the AI assisted actions (e.g., the actions on the received incident mentioned above) and/or an indication thereof to the related entities, such as isolation of an entity, reconfiguration of network, increasing processing capabilities, increase bandwidth of certain interfaces, etc. in accordance with the decision made by the AISC.

The AISC may acknowledge the notification received (e.g., the notification that communicates the anomaly).

6G may rely on edge intelligence and federated learning for network security, ensuring communication efficiency. AI at different levels in the network hierarchy may block DoS attacks and manage authentication and authorization efficiently. Federated learning may enable different levels of AI training without sharing the local training data (e.g., for a purpose that involves preserving privacy).

AI may play a role in 6G networks security by enabling intelligent threat detection, automation, and self-healing capabilities. For example, autonomous threat detection and/or mitigation with AI-powered network forensics may detect a known attack with a signature-based intrusion detection system (IDS) and detect zero-day threats using anomaly detection mechanism.

For example, intelligent beamforming techniques based on reinforcement learning may provide optimal and/or near optimal beamforming policies against eavesdropper attacks. AI-based anomaly detection systems may detect jamming attacks and prevent node compromise attacks.

AI in 6G may play a role in modern threat detection by enhancing the ability to identify, analyze, and respond to cyber threats in real-time. Some possible examples of the role AI may play (e.g., in threat detection) are listed below.

AI in 6G may play a role in threat detection by performing automated threat identification. AI models may sift through vast amounts of data to identify patterns and anomalies that may indicate a potential threat. This automation may allow quicker detection compared to traditional methods.

AI in 6G may play a role in threat detection by performing predictive analytics. Machine learning models may predict potential vulnerabilities and threats by analyzing historical data and identifying trends. This proactive approach may help in mitigating risks before they may be exploited.

AI in 6G may play a role in threat detection by performing real-time monitoring. AI systems may continuously monitor network traffic and user behavior, providing immediate alerts when suspicious activities are detected. This real-time analysis may enable faster response times to potential security incidents.

AI in 6G may play a role in threat detection by enhancing accuracy. AI may improve the accuracy of threat detection by reducing false positives and/or false negatives. Advanced algorithms may distinguish between benign and malicious activities more effectively than traditional rule-based systems.

AI in 6G may play a role in threat detection by performing adaptive learning. AI systems may learn and adapt over time, improving their threat detection capabilities as they are exposed to new types of cyber threats. This adaptability may allow such AI systems to keep up with the evolving tactics of cybercriminals.

AI in 6G may play a role in threat detection by performing incident response automation. AI may automate one or more responses to detected threats, such as isolating affected systems or blocking malicious traffic. This automation may reduce (e.g., minimize) the impact of security incidents.

AI-assisted security and/or privacy may be a part of AI's role in 6G systems. Some possible examples of the role AI may play (e.g., in enhancing security and/or privacy) are listed below.

AI in 6G may play a role in enhancing security and/or privacy by implementing edge intelligence. Distributed edge-based federated learning for network security may be used to ensure communication efficiency and robust security in a massive device and/or data regime.

AI in 6G may play a role in enhancing security and/or privacy by implementing behavior-based approaches. AI at the tiny cell level may block Denial of Service (DoS) attacks, while multi-connectivity may allow base stations to evaluate device behavior using AI classification algorithms to reduce overhead from frequent key exchanges and may enable dynamic, behavior-based authentication.

AI in 6G may play a role in enhancing security and/or privacy by implementing federated learning for authorization. Different levels of authorization for sub-network and wide area network levels with trust scores learned within sub-networks may be shared externally if certain conditions are met (but not shared externally if such conditions are not met), enhancing security without compromising efficiency.

AI in 6G may play a role in enhancing security and/or privacy by implementing learning-based intrusion detection. AI may be used to prevent attacks on Control Plane Management Systems (CPMS) and User Plane Management Systems (UPMS) using data already available at the edge to provide intelligent service provision and robust security.

AI in 6G may play a role in enhancing security and/or privacy by implementing Zero-Touch Management (ZSM). Systems may be equipped with domain analytics and domain intelligence services for automated network management to enhance security through AI model assessment and API security, ensuring a secure and efficient network management framework.

6G networks may rely heavily on advanced data collection frameworks to support AI-assisted security and other functionalities. Some examples of how 6G networks may rely on advanced data collection frameworks to support AI-assisted security and other functionalities are listed below.

6G networks may rely on advanced data collection frameworks to support AI-assisted security and other functionalities such as multi-layered data collection. Data from virtual and physical network components may be integrated, enhancing operational insights to collect data from IoT devices, edge servers, and cloud infrastructure to provide a comprehensive view of network performance and security.

6G networks may rely on advanced data collection frameworks to support AI-assisted security and other functionalities such as multi-layered data collection. A robust foundation for network management may be provided by analyzing data in real-time using AI algorithms to monitor network traffic and detect anomalies rapidly (e.g., instantly), facilitating prompt responses to security threats.

6G networks may rely on advanced data collection frameworks to support AI-assisted security and other functionalities such as network digital twins. Virtual replicas of physical network components may be created to simulate and analyze their behavior by employing digital twins to predict potential failures and optimize network configurations based on real-time data.

6G networks may rely on advanced data collection frameworks to support AI-assisted security and other functionalities such as synergetic orchestration. Data collection and analysis across multiple network domains may be coordinated by integrating data from various sub-networks to enhance overall network security and efficiency.

6G networks may rely on advanced data collection frameworks to support AI-assisted security and other functionalities such as management capabilities exposure framework(s). The exposure of management capabilities across network domains may be streamlined to provide consistent access to data for AI-driven applications, facilitating seamless integration and innovation.

In the SBA, there are gaps in the current security requirements in 3GPP that make detection of threats difficult. Some examples of types of security incidents and/or scenarios in the network for which data should be collected are listed below.

In the SBA, it may be difficult to detect an authentication and/or authorization failure event.

In the SBA, it may be difficult to detect an unexpected setup of a transport Layer Security (TLS) session and/or API invocation related to unauthorized reconnaissance.

In the SBA, it may be difficult to detect a malformed message event.

In the SBA, it may be difficult to detect a high service load.

In the SBA, it may be difficult to detect unexpected SBI call flows.

In the SBA, it may be difficult to detect unexpected use of APIs exposed by services in an SBA layer.

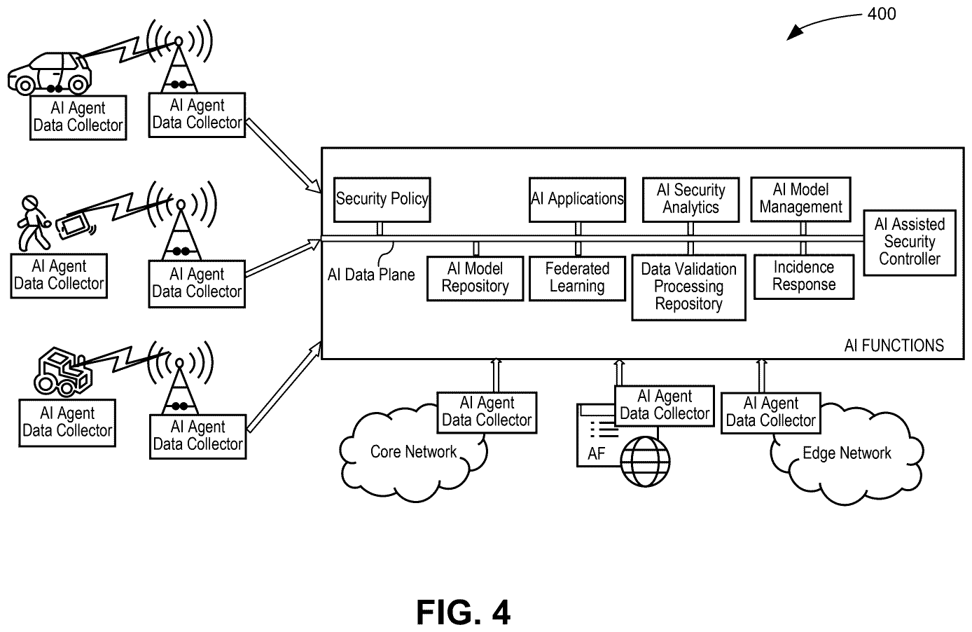

An example architecture described herein (e.g., as shown in FIG. 4) aims to provide an extensive (e.g., comprehensive) and/or robust security framework for the next generation of wireless communication. The functions described below may play roles in the AI assisted 6G security as shown in the FIG. 4.

The AISC may be the central hub for monitoring and managing security across the network. AI may enhance its capabilities by automating threat detection, analysis, and response. The AISC may enable faster identification of threats, reduced response times, and increased accuracy in detecting anomalies.

In the example architecture, the Zero-Trust architecture may be integrated to reduce (e.g., minimize) the risk of internal and external threats by ensuring that only authenticated and authorized entities can access network resources. The architecture may be compatible with Quantum-Safe Encryption to ensure the confidentiality and integrity of data even in the face of future quantum computing threats.

At the network edge, AI assisted edge security may protect data and applications, where data may be processed closer to its source rather than in a centralized data center, to reduce latency, enhance performance, and enhance security by reducing (e.g., minimizing) the attack surface.

In addition, the example architecture and/or functions described herein may automatically clean, enrich, and validate data to ensure it is accurate and up to date. The example architecture and/or functions may implement robust AI security for data security measures such as encryption, access controls, and advanced security techniques. The example architecture and/or functions may develop transparent data privacy policies that anonymize and protect sensitive information. The data integration may seamlessly connect and transform data across various platforms and applications.

FIG. 4 illustrates an example architecture 400 (e.g., Next Gen Network Architecture) with AI-assisted security.

The example architecture 400 depicts functionalities (e.g., AI functions) such as an AI-assisted security controller, AI model management, AI applications, a data validation processing repository, security policy, federated learning, AI agent data collectors, an AI model repository, incidence response, etc.

Once AI agent data collectors collect raw security data (e.g., from NFs, the RAN, WTRUs, etc.), they may aggregate and analyze the collected raw security data using AI based analytics.

Once the raw security data has been collected, AI techniques for anomaly detection may be applied. Some examples of AI techniques for anomaly detection that may be applied are listed below.

Supervised and/or unsupervised learning may be applied by AI agents (e.g., AI agents in WTRUs, RAN network nodes, AFs, etc.). AI agents (e.g., AI agent data collectors) may compare real-time data with historical patterns to detect outliers.

Reinforcement learning (e.g., in the form of some types of AI models) may be applied (e.g., by RAN network nodes, WTRUs, AFs, etc.). AI models may dynamically adapt to emerging threats by learning from new attack patterns.

Graph Neural Networks (GNNs) may be applied (e.g., by RAN network nodes, WTRUs, AFs, etc.). GNNs may be used to analyze the relationship(s) between WTRUs, the RAN, and/or network elements to uncover hidden attack paths.

Explainable AI (XAI) may refer to artificial intelligence systems designed to be transparent and understandable to humans. One goal of XAI may be to make the decision-making processes of AI models more interpretable, so users can understand, trust, and effectively manage these systems (e.g., systems that use AI models). Some features of XAI are listed in the examples below.

Some examples of XAI may provide transparency. XAI aims to provide clear insights into how AI models make decisions, including the data and algorithms used.

Some examples of XAI may provide interpretability. For instance, XAI may make AI outputs understandable to non-experts, often through visualizations or simplified explanations.

Some examples of XAI may provide accountability. By making AI decisions explainable, XAI makes it easier to identify and correct errors or biases, ensuring more ethical and fair outcomes.

Some examples of XAI may provide trust. When users understand how AI systems work, users are more likely to trust and adopt these technologies (e.g., AI systems).

Some of the functionalities and/or benefits of some of the elements shown in FIG. 4 are described below.

The AI Assisted Security Controller (AISC) may monitor network traffic and/or security events (e.g., in real-time) using AI algorithms and/or models to detect and respond to threats swiftly. The AISC may leverage machine learning to predict potential security breaches and automate responses.

The AISC may enhance threat detection accuracy, reduce response time, and/or reduce (e.g., minimize) human intervention.

The AI model management function may manage the lifecycle of AI models, including training, validation, deployment, and/or monitoring. The AI model management function may ensure that models are up-to-date and performing well (e.g., optimally).

The AI model management function may maintain the effectiveness of AI-driven security measures and adapts to evolving threats.

The AI security analytics (AISA) function may use one or more AI models to detect and/or predict anomalies and/or security incidents in the 6G network.

The AISA function may facilitate the XAI to a transparent and actionable response.

The data validation processing repository function may ensure the integrity and/or quality of data used by AI models. The data validation processing repository function may validate, clean, and/or process data before storing it in a repository.

The data validation processing repository function may increase the accuracy of AI predictions and decisions by using high-quality data.

The security policy function may define and/or enforce security policies across the network. The security policy function may use AI to adjust policies dynamically based on threat intelligence and network conditions.

The security policy function may enhance network security by adapting policies in real-time to counteract emerging threats.

The AI applications function may deploy AI applications for various security tasks, such as intrusion detection, anomaly detection, and/or threat intelligence.

The AI applications function may automate complex security tasks, which for example, may improve efficiency and/or effectiveness.

The federated learning function (e.g., distributed learning function) may enable multiple entities to train AI models collaboratively without sharing raw data. The federated learning function may use decentralized data to improve model accuracy while preserving privacy.

The federated learning function may enhance model performance and security without compromising data privacy.

The AI agent data collectors may collect data from various network elements and/or devices for analysis by AI models. The AI agent data collectors may, for example, ensure wide (e.g., comprehensive) data coverage for accurate threat detection.

The AI agent data collectors may provide a rich dataset for AI analysis, which for instance, may enhance the detection of and response to security incidents.

The incidence response function may use AI to identify, analyze, and/or respond to security threats and incidents. The incidence response function may automate the incident response process to mitigate risks quickly.

The incidence response function may reduce the impact of security breaches by enabling rapid and effective responses.

These functionalities (e.g., functions) collectively may enhance the security of networks (e.g., 6G networks) by leveraging AI to automate and/or enhance various aspects of threat detection, response, and/or management.

The AISA and the AI agent data collectors may collaborate to (e.g., NWDAF as the AISA and AI Agent data collectors installed at NFs and/or WTRUs) to collect information on distributed functionalities and interfaces between 6G entities (e.g., WTRUs, RAN, NFs).

Data collection from Interfaces/Protocols (e.g., 6G Interfaces/Protocols) in the U-plane, C-plane, and/or Service-plane (e.g., SBI) may be performed.

U-plane and C-plane messages with packet metadata such as nodes connected, protocols, header fields, etc. may be collected (e.g., by AI agents in WTRUs and/or RAN network nodes, AFs, etc.).QoS parameters such as signaling message rate, packet drop rate, round trip time, etc. may be collected (e.g., by AI agents in WTRUs and/or RAN network nodes, AFs, etc.).

Signaling messages with metadata such as message type and length sender and/or receiver may be collected (e.g., by AI agents in WTRUs and/or RAN network nodes, AFs, etc.). API invocations with metadata (e.g., evidencing API misuse, privilege escalation, etc.) may be collected (e.g., by AI agents in WTRUs and/or RAN network nodes, AFs, etc.).

The RAN may be a point for security monitoring because the RAN handles radio signals and interfaces between WTRUs and the core network. AI agents may extract raw data from RAN components. The AI data collected may be used to detect signal interference, rogue base stations, RAN traffic unusual patterns, such as DDoS attacks, rogue base stations, or unauthorized spectrum usage; radio signal strength, interference levels, and transmission patterns to detect jamming attacks, spoofing, or unauthorized network access; cell handover and/or mobility patterns such as sudden disconnections or unauthorized network switching. The data collection in the RAN may include (e.g., but is not limited to) types of data listed in the following examples.

Data collectors (e.g., AI agent data collectors) in the RAN may collect data associated with network traffic. AI agents may continuously scan and analyze RAN traffic to detect unusual patterns, such as DDoS attacks, rogue base stations, or unauthorized spectrum usage.

The data collectors in the RAN may collect data associated with coverage/radio signal. AI models may analyze signal strength, interference levels, and transmission patterns to detect jamming attacks, spoofing, or unauthorized network access.

The data collectors in the RAN may collect data associated with cell handover and/or mobility patterns. AI agents may monitor user mobility and handover data to identify abnormal behaviors, such as sudden disconnections or unauthorized network switching.

The data collectors in the RAN may collect data associated with failure cases. AI agents continuously collect and analyze the failure cases, such as Radio Link Failure, Handover Failures, etc. from RAN to detect various attacks.

Several examples for security threat detection in the RAN are listed below.

The RAN may use an AI-Based Intrusion Detection Systems (IDS) for security threat detection. AI agents may use machine learning to recognize known and unknown attack patterns on RAN interfaces based on supervised and/or unsupervised learning.

The RAN may use AI models deployed at the edge to process security data locally to enable low-latency anomaly detection.

The RAN may use federated learning to allow AI agents in different RAN nodes to collaborate to share insights without exposing raw user data.

WTRUs may include devices such as smartphones, IoT devices, and/or autonomous systems (e.g., among other possible types of WTRUs). AI agents in devices may monitor these devices for security threats and anomalies. Data collection from WTRUs may include (e.g., but is not limited to) the types of data listed in the following examples.

AI agents may collect WTRU parameters, failures, Operating System (OS version), software installed and/or patches, configured parameters, sanity state check, associated user ID, and/or connections to monitor for security threats and anomalies.

AI agents may collect WTRU behavioral data to monitor for security threats and anomalies. AI agents may analyze user behavior patterns (e.g., browsing habits, application usage, location, etc.) to detect potential account takeovers and/or insider threats.

AI agents may collect device telemetry and/or logs to monitor for security threats and anomalies. AI agents may collect system logs, Central Processing Unit (CPU) usage, memory consumption, and/or battery performance to detect malware and/or unauthorized modifications.

AI agents may collect biometric and/or authentication data to monitor for security threats and anomalies. AI agents may enhance authentication mechanisms by continuously verifying the user's biometric signatures (e.g., gait recognition, facial patterns, etc.).

AI agents may collect data from 5G/6G protocol monitoring to monitor for security threats and anomalies. AI agents may detect protocol misuse and/or exploitation of vulnerabilities in WTRU-to-network communication (e.g., replay attacks, session hijacking, etc.).

Several examples for security threat detection and/or response in WTRUs are listed below.

AI agents may perform security threat detection and/or response in WTRUs by implementing malware and/or rogue-application detection. AI agents may analyze application behavior, permission requests, and/or network activity to identify malicious applications.

AI agents may perform security threat detection and/or response in WTRUs by implementing compromised device detection may be used. AI agents may look for signs of rooted devices, unauthorized firmware modifications, and/or abnormal data transmissions.

AI agents may perform security threat detection and/or response in WTRUs by implementing unauthorized-access detection. For instance, WTRU access of a resource that is not authorized may be detected (e.g., by an AI agent).

AI agents may perform security threat detection and/or response in WTRUs by implementing WTRU isolation. If an anomaly is detected, an AI agent may automatically quarantine the WTRU and/or restrict network access of the WTRU.

Network Functions (NFs) may include core network entities, base stations, edge servers, and/or operator-owned servers (among other possibilities). AI agents in NFs may monitor these entities for security threats and anomalies.

AI agents in NFs may monitor for traffic anomalies, data exfiltration, and/or network slice (e.g., service degradation, misconfigurations).

AI agents in NFs may continuously monitor network telemetry and logs, past incidents, sensitive network management operations, management login/logoff events, configuration modification, etc.

AI agents in NFs may monitor Operations, Administration, and/or Maintenance (OA&M) and/or NF parameters, patches, vulnerabilities, and/or traffic parameters.

In an example, AI agents in NFs may monitor security events. AI agents may monitor failure sources, root cause(s), reception of a massive number of incoming messages, etc.

AI agents in NFs may monitor CPU occupancy, processing capability, remaining processing capability, and/or resource usage.

AI agents in NFs may monitor queue length and/or queue wait time.

AI agents in NFs may monitor signaling message processing rate(s).

AI agents in NFs may monitor data on API malformed messages received that are different from standard messages and/or are considered invalid according to the protocol specification and network state.

AI agents in NFs may monitor for failed authentication and/or authorization attempts from inbound connections (e.g., potential replay attacks, abnormal API call flows as defined for the communication, etc.).

The Security Analytic (AISA) may be responsible for the data collection control to collect data from monitored entities, such as WTRUs, RAN, NFs, Network Exposure Functions (NEFs), Network Repository Functions (NRFs), Application Functions (AFs), etc., with the assistance from the AI Agent/data collector in each entity. The data collected by the AI agent data collector may be used by the AISA along with the AI model for threat detection and/or incidence response. The AISA may have a dynamic view of the network configuration and the AI model may be adapted with changes of the network interfaces, processing capabilities, configuration, and/or network topology.

Technologies described herein (e.g., the AISA) may aim to detect and/or mitigate a signaling storm in a dynamically adapted networking environment via dynamic and/or flexible networking such as software-defined networking capability. This aim may be achieved by adding dynamic network signaling processing capability, load balancing, interface and/or bandwidth change, as well as the topology change. Technologies described herein (e.g., the AISA) may perform the mitigation of signaling storm dynamically and/or greatly enhance the network usability without adversely restricting the normal network loads.

Network configuration updates and/or NF-capability changes may trigger AI-model adaptation and/or update.

An AI model (e.g., a respective AI model) may be associated with each network configuration. A network configuration may be pre-defined with an associated pre-trained AI model (e.g., a respective associated pre-trained AI model). For example, an AI model trained for network load traffic such as with a stadium sport event with 100K+attendants) may be activated with an associated network configuration when the stadium sport event is detected.

If there is no existing pre-defined network configuration as recommended updates, the current networking may be re-configured, and AI may be re-trained and/or updated for a recommended new configuration.

This example (e.g., regarding the AISA) may be used to detect DDoS attacks and/or signaling storms and to trigger and/or perform automatic networking response via reconfiguration to adapt the network configuration as the network load changes.

The AISC may subscribe to and/or receive notifications of network monitoring data (e.g., the types of data that may be collected, as described above). For signaling storm detection, additional signaling traffic information including SBI API monitoring data from associated interfaces may be collected. The AISC may process the data from each network interface and/or signaling processing NFs for the AI detection.

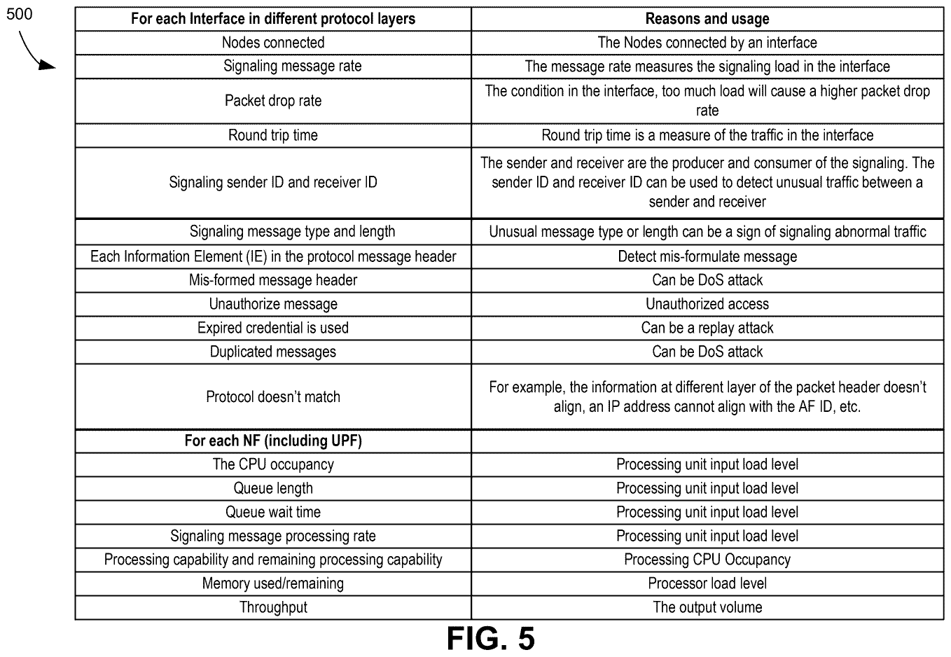

FIG. 5 shows a table 500 that illustrates some types of data that may be collected and used by the AISC.

A service operations call rate that indicates the number of service operations calls an NF receives over an SBI per time period (e.g., per hour, minute, second, etc.) may be used. The NF may provide the relative distribution of NF IDs originating the Service Operations. A malformed service operations metric (e.g., in the form of rate, counter, etc.) may be used. The NF may provide the ID of the NF originating the service operation. A service operations time out metric (e.g., in the form of rate, counter) may be used. The invoking NF may provide the ID of the unresponsive target NF.

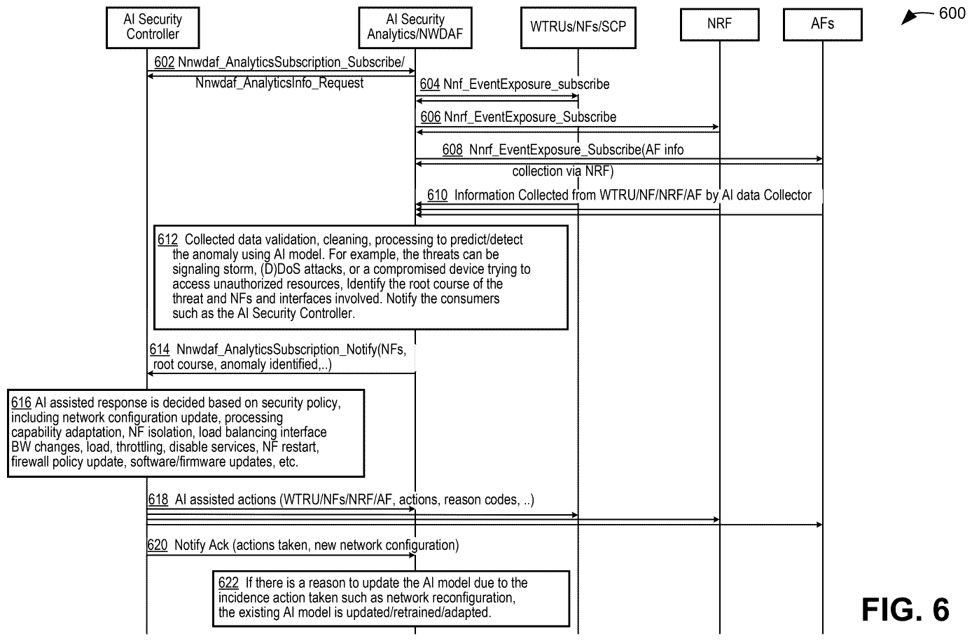

FIG. 6 illustrates an example call flow diagram 600 for AI-based threat detection and/or response (e.g., a threat such as a signaling storm, a DDoS attack, etc.).

Before the AI assisted security monitoring and detection process depicted by the example call flow diagram 600, an AI model may be trained and/or tested using existing data. In AI model training, network traffic data and/or data from various network points (e.g., network sources) may be collected to monitor traffic patterns. Device data (e.g., from WTRUs) may include logs from devices to track their activities and/or behaviors and/or historical attack data from past security incidents to train the AI model. Data preprocessing may be performed and may include data cleaning to remove irrelevant and/or redundant data to ensure quality, data normalization to standardize data formats and/or proper data sizing to ensure consistency, and/or feature extraction to identify and/or extract relevant features that may indicate unauthorized access, such as unusual traffic patterns or login attempts. After preprocessing (e.g., to produce labeled and/or unlabeled training data from the raw collected data), model training with algorithm selection may be performed to choose appropriate AI algorithms and/or models, such as deep learning models, for anomaly detection. Techniques such as supervised learning may be effective in detecting unauthorized access.

To train the AI model, labeled data (e.g., normal vs. compromised) may be used. The AI model may be validated using a separate dataset (e.g., test data) to ensure that the AI model generalizes well to new, unseen data.

Information used for the AI model may include training data, historical data on network traffic, device logs, and/or past security incidents, and/or feature indicators of compromise, such as unusual login times, high data transfer rates, and/or unexpected IP addresses. The training data may also include labels such as normal and/or compromised to train the model effectively. After the training, evaluation metrics such as precision, recall, and/or F1-score may be used to evaluate the AI model's performance.

Example Techniques that may be used in the AI training may include (but are not limited to) Principal Component Analysis (PCA) (e.g., for dimensionality reduction and/or feature selection), deep learning models (e.g., capsule networks for effective anomaly detection), and/or optimization algorithms like Spotted Hyena Optimization (e.g., for feature selection).

The call flow diagram 600 depicts eleven example steps which are described in further detail below. In some examples, some of the steps may be performed in an order other than the order shown in the call flow diagram 600. In addition, in some examples, some steps may be removed and/or other steps not shown in the call flow diagram 600 may be performed.

In step 602, the AI Security Controller (AISC) subscribes to the AI security analytics derived by an AI model that may be collocated with an NWDAF (e.g., the AI Security Analytics/NWDAF, which may represent an AISA function in FIG. 6). The AISC is collocated with a security policy repository and/or configured with the security policy repository address.

In step 604, the AI Security Analytics/NWDAF subscribes with the WTRUs/NFs/SCP for the collection of the network information described above, such as signaling data and/or signaling traffic load-related information via respective AI agent data collectors that are integrated in the respective entities where the monitoring data is collected. Note that a subscribe acknowledgment is omitted in the call flow diagram 600.

In step 606, the AI Security Analytics/NWDAF subscribes with the NRF for the collection of the network information described above, such as signaling data and/or signaling traffic load-related information. Note that a subscribe acknowledgment is omitted in the call flow diagram 600.

In step 608, the AI Security Analytics/NWDAF subscribes with the AFs for the collection of the network information described above, such as signaling data and/or signaling traffic load-related information. Note that a subscribe acknowledgment is omitted in the call flow diagram 600.

In step 610, the AI Security Analytics/NWDAF receives the collection of network information from the WTRUs/NFs/SCP, the NRF, and the AFs based on the subscribing described with respect to steps 2-4.

In step 612, the AI Security Analytics/NWDAF validates, cleans, and processes the collected data to predict and/or detect the network anomaly such as a signaling storm, a (D) DoS attack, or a compromised device that tries to access an unauthorized resource, using the Explainable AI (XAI). The AI Security Analytics/NWDAF identifies the NFs and interfaces impacted by the security incident such as the signaling storm and identifies the root course and NFs along with the interfaces involved. The AI Security Analytics/NWDAF may send the incident notification to any authorized subscribers such as the AISC referred to in step 602.

In step 614, The AI Security Analytics/NWDAF notifies the ASIC and communicates the anomaly, the associated root course, the entity ID involved, etc. An example incident may indicate a compromised NF ID and the type of anomaly affecting that NF (e.g., sending malformed SBI requests, flooding message over SBI, unresponsive). Another example incident may comprise a large volume of SBI API invocations between an external AF and the NEF in the operator's core network with an unusual Information Element (IE) in the SBI header and/or unauthorized access of a resource in the core network. This information may collectively be identified as a threat from a compromised AF (if it is from a known AF using a corrected digital signature). Another example incident may be if the core network/RAN detects mis-formulated messages from a WTRU and/or if the WTRU tries to access NFs that the WTRU is not authorized to access.

In step 616, the AISC determines an AI assisted security incident response based the notification from the AI Security Analytics/NWDAF and on security policy. The response may include a network configuration update, processing capability adaptation, NF isolation, load balancing, interface BW changes, load, throttling, disabling services, NF restart, a firewall policy update, software/firmware updates, etc. For example, if a signaling storm is identified, the network configuration-such as signaling message processing capability adaptation, load balancing, interface BW changes, isolation of certain entities, throttling of signaling load, etc.—is updated based on recommendations received in step 614. The response may also impact the QoS policy, for example, lower the WTRU priority level, reduce the WTRU Aggregate Maximum Bit Rate (e.g., the UE-AMBR if the WTRU is a UE), reduce the maximum data burst volume, etc. In that case the AISC may determine, for example, to interact with the SMF and/or PCF serving the WTRU. In general, in the case of a misbehaving WTRU, the AISC may determine, for example, to perform remediation actions with access control and/or session management functions serving the WTRU (e.g., AMF, SMF, PCF, UDM/UDR).

If a misbehaving AF is detected, the AISC may determine, for example, to perform remediation actions with the NEF serving the AF.

In step 618, the AI assisted actions (e.g., indications thereof) are sent to the related entities. The AI assisted actions may comprise, for example, isolation of an entity, reconfiguration of the network, increasing processing capabilities, increasing bandwidth of certain interfaces, etc. as determined in the decision made by the AISC.

For example, in response to receiving a notification from the AI Security Analytics/NWDAF indicating an NF being compromised, the AISC may determine, based on the security policy, to isolate the compromised NF. The AISC may inform NRF(s) and/or SCP(s) about the identifier (e.g., NF ID, the Fully Qualified Domain Name (FQDN)) of the compromised NF to take action about the NF. For example, in response to the notification from the AISC, the NRF may prevent subsequent discovery of the compromised NF (e.g., by removing a stored NF profile). For example, the SCP may reject requests from other NFs to contact the compromised NF (e.g., refrain from providing an authorization token for communication with the compromised NF). The SBI related communication functions (e.g., NRF, SCP) are subscribed with the AISC for incident response notification.

For example, in the case of a misbehaving WTRU, the AISC may notify the SMF and/or Point Coordination Function (PCF) about the misbehaving WTRU. The AISC may provide a remediation indication, for example, instructing the SMF and/or PCF to update (e.g., lower priority, data rate) the QoS available to the WTRU. The SMF may configure the RAN and/or UPF accordingly based on the QoS. In another example, the AISC may instruct the PCF to send a new Universal Software Radio Peripheral (URSP) policy to the WTRU. In another example, the AISC may instruct the SMF to release the Protocol Data Unit (PDU) session.

In another example, the AISC may notify the AMF about the misbehaving WTRU. The AISC may instruct the AMF to stop processing NAS messages from the WTRU and/or disconnect the WTRU from the network.

The AISC may notify the UDM and/or User-Defined Route (UDR) about the misbehaving WTRU. The AISC may indicate to the UDM and/or UDR to mark the WTRU as compromised. Subsequently, the UDM and/or UDR may reject and/or throttle subsequent WTRU authentication requests (e.g., requests associated with the WTRU).

For example, in the case of a misbehaving AF, the AISC may notify the NEF about the misbehaving AF. The NEF may subsequently disconnect the AF and reject further API access requests (e.g., blacklist the AF domain).

In the above examples, the AISC may notify Operation and Maintenance (O&M) about incidents. O&M may take network level actions such as network re-configurations, isolation of sub-networks, and/or virtualization platforms.

In step 620, the AISC acknowledges the notification received in step 614.

In step 622, if there is a need to update the AI model due to the actions taken as the incidence response (e.g., as described with respect to in step 618), the existing AI Model and associated network configuration (e.g., as described with respect to step 6) are saved for future reference. The AI model is updated and/or re-trained for the new network configuration.

1. A network device in a cellular network, the network device comprising:
a processor configured to:
receive a notification, the notification comprising an indication that a security incident associated with the cellular network has been detected, an indication of a type of the security incident, and an indication of a first network entity associated with the security incident;
determine, via an artificial intelligence (AI) model based on the notification, at least one action to be performed by a second network entity in response to the security incident; and
send an indication of the at least one action to the second network entity to instruct the second network entity to perform the at least one action.

2. The network device of claim 1, wherein the at least one action comprises a configuration update for the cellular network.

3. The network device of claim 1, wherein the first network entity associated with the security incident is a wireless transmit/receive unit (WTRU), and wherein the at least one action comprises reducing an aggregate maximum bit rate for the WTRU.

4. The network device of claim 1, wherein the type of the security incident is a signaling storm, and wherein the at least one action comprises a signaling message processing capability adaptation, load balancing, an interface bandwidth change, or throttling a signaling load.

5. The network device of claim 1, wherein the first network entity associated with the security incident is an application function (AF), and wherein the type of the security incident is a malformed service-based interface (SBI) request or a large volume of SBI application programming interface (API) invocations between the AF and a network exposure function (NEF) with an unusual information element (IE) in an SBI header.

6. The network device of claim 1, wherein the second network entity comprises a network repository function (NRF), and wherein the first network entity associated with the security incident comprises a network function (NF).

7. The network device of claim 6, wherein the at least one action comprises the NRF removing a stored profile for the NF.

8. The network device of claim 1, wherein the second network entity comprises a service communication proxy (SCP), and wherein the first network entity associated with the security incident comprises a network function (NF).

9. The network device of claim 8, wherein the at least one action comprises the SCP refraining from providing an authorization token for communication with the NF.

10. The network device of claim 1, wherein the second network entity comprises a session management function (SMF), and wherein the at least one action comprises the SMF releasing a protocol data unit (PDU) session.

11. The network device of claim 1, wherein the processor is further configured to:
prior to receiving the notification, send a request to subscribe to AI security analytics derived by a second AI model.

12. The network device of claim 1, wherein the processor is further configured to:
send an acknowledgment in response to receiving the notification.

13. A method performed by a network device in a cellular network, the method comprising:
receiving a notification, the notification comprising an indication that a security incident associated with the cellular network has been detected, an indication of a type of the security incident, and an indication of a first network entity associated with the security incident;
determining, via an artificial intelligence (AI) model based on the notification, at least one action to be performed by a second network entity in response to the security incident; and
sending an indication of the at least one action to the second network entity to instruct the second network entity to perform the at least one action.

14. The method of claim 13, wherein the at least one action comprises a configuration update for the cellular network.

15. The method of claim 13, wherein the first network entity associated with the security incident is a wireless transmit/receive unit (WTRU), and wherein the at least one action comprises reducing an aggregate maximum bit rate for the WTRU.

16. The method of claim 13, wherein the type of the security incident is a signaling storm, and wherein the at least one action comprises a signaling message processing capability adaptation, load balancing, an interface bandwidth change, or throttling a signaling load.

17. The method of claim 13, wherein the first network entity associated with the security incident is an application function (AF), and wherein the type of the security incident is a malformed service-based interface (SBI) request or a large volume of SBI application programming interface (API) invocations between the AF and a network exposure function (NEF) with an unusual information element (IE) in an SBI header.

18. The method of claim 13, wherein the second network entity comprises a network repository function (NRF), and wherein the first network entity associated with the security incident comprises a network function (NF).

19. The method of claim 18, wherein the at least one action comprises the NRF removing a stored profile for the NF.

20. The method of claim 13, wherein the second network entity comprises a service communication proxy (SCP), and wherein the first network entity associated with the security incident comprises a network function (NF).
